(19) United States
(12) Patent Application Publication
(10) Pub. No.: US 2019/0005289 A1
(43) Pub. Date: Jan. 3, 2019

(54) IMAGE CODE RECOGNITION APPARATUS

(71) Applicant: SAMSUNG SDS CO., LTD., Seoul (KR)

(72) Inventor: Kyunguk KIM, Seoul (KR)

(73) Assignee: SAMSUNG SDS CO., LTD., Seoul (KR)

(21) Appl. No.: 16/022,958

(22) Filed: Jun. 29, 2018

(30) Foreign Application Priority Data
Jun. 29, 2017 (KR) 10-2017-0082225

(51) Int. Cl. G06K 7/14; H04W 4/80; G06K 7/10

(52) U.S. Cl. CPC G06K 7/1417; G06K 7/10722; H04W 4/80

(57) ABSTRACT

According to an embodiment, an image code recognition apparatus may include a first light emitting device configured to emit light, in a first region of an electromagnetic spectrum, towards the image code; an optical sensor configured to sense light reflected from the image code; a controller configured to extract the information included in the image code based on the sensed light; a wireless communication device configured to transmit the information to the wireless terminal via wireless communication; a housing configured to accommodate the first light emitting device, the optical sensor, the controller, and the wireless communication device; and a second light emitting device configured to emit light in a second region of the electromagnetic spectrum, wherein the housing includes a coupling portion forming an internal space in which the second light emitting device is inserted and coupled to a front end of the first light emitting device.

This application claims priority from Korean Patent Application No. 10-2017-0082225 filed on Jun. 29, 2017 in the Korean Intellectual Property Office, the disclosure of which is incorporated herein by reference in its entirety.

### BACKGROUND

### 1. Field of the Disclosure

The present disclosure relates to an image code recognition apparatus, and more particularly, to an image code recognition apparatus capable of recognizing image codes displayed by not only light in a visible light region of the electromagnetic spectrum but also light in a non-visible light region of the electromagnetic spectrum.

### 2. Description of the Related Art

Generally, codes are predetermined representations of objects which are expressed and recognized through English letters, numbers, or special symbols. However, memorizing individual codes and inputting the codes into a computer are very inconvenient and difficult.

In order to address the above problem, instead of general codes, there is a barcode, which is formed by combining bars having different widths, and a quick response (QR) code, which is a two-dimensional barcode in a matrix form representing information as a black and white grid pattern. An apparatus that optically reads the barcode or the QR code and inputs the barcode or the QR code into a computer is referred to as an image code scanner.

The image code scanner is a type of input device that reads an electronic signal generated according to the intensity of the light reflected from applying light to a printed image code. The image code scanner uses an optical principle in which an electronic signal is generated according to the intensity of light reflected from applying light to an input medium on which an image code is printed whereby a logic circuit is operated with the generated electronic signal so that the generated electronic signal is converted into an internal code of a computer.

Conventional image code scanners simply sense image codes which are recognizable in a visible light region and extract information included in the image codes.

However, in a special case (e.g., in a case of semiconductor or a display manufacturing process), there is a need to display and recognize an image code of a product in order to track progress of the product. In the case in which the image code is displayed in a form recognizable in the visible light region, the image code displayed in the visible light region may not be used because the image code can be determined as being defective in a process of determining a defect of a product using an image of the product.

In order to address the above problem, conventionally, an image code is displayed on a product using a special ink (e.g., an ultraviolet light-emitting ink or an infrared light-emitting ink) which allows an image code to be displayed only in a non-visible light region (e.g., an infrared ray or an ultraviolet ray region), and the product is taken to a dark room with non-visible light wherein the image code is recognized. Therefore, working time is wasted and work is inconvenient due to a time during which an operator moves in order to recognize the image code.

Further, there is a problem in that such an apparatus for recognizing the image code with non-visible light can require separate non-visible light in order to recognize the image code displayed in a non-visible light region or recognize the image code only in a special place in which non-visible light is emitted.

### SUMMARY

Aspects of the present disclosure provide an image code recognition apparatus capable of recognizing image codes displayed by not only light in a visible light region but also light in a non-visible light region.

It should be noted that an object of the present disclosure are not limited to the above-described object, and other objects of the present disclosure will be apparent to those skilled in the art from the following descriptions.

In some embodiments, an image code recognition apparatus comprises a first light emitting device configured to emit light, in a first region of an electromagnetic spectrum, towards the image code; an optical sensor configured to sense light reflected from the image code; a controller configured to extract the information included in the image code based on the sensed light; a wireless communication device configured to transmit the information to the wireless terminal via wireless communication; a housing configured to accommodate the first light emitting device, the optical sensor, the controller, and the wireless communication device; and a second light emitting device configured to emit light in a second region of the electromagnetic spectrum, wherein the housing includes a coupling portion forming an internal space in which the second light emitting device is inserted and coupled to a front end of the first light emitting device.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a perspective view for describing an image code recognition apparatus according to an embodiment of the present disclosure;

FIG. 2 is an exploded perspective view for describing the image code recognition apparatus of FIG. 1;

FIG. 3 is a configuration diagram for describing the image code recognition apparatus according to an embodiment of the present disclosure;

FIG. 4 is a perspective view for describing an appearance of a wireless terminal mounting portion of the image code recognition apparatus of FIG. 1 when a wireless terminal is mounted thereon;

FIG. 5 is a front view for describing the image code recognition apparatus in which a second light emitting unit of FIG. 1 is separated;

FIG. 6 is a front view for describing the second light emitting unit of FIG. 1;

FIG. 7 is a rear view for describing the second light emitting unit of FIG. 1; and

FIG. 8 is a plan view for describing the second light emitting unit of FIG. 1.

### DETAILED DESCRIPTION OF THE EMBODIMENTS

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the present disclosure to those skilled in the art, and the present disclosure will only be defined by the appended claims. In the drawings, the size and relative sizes of layers and regions may be exaggerated for clarity. Like reference numerals refer to like elements throughout the specification. The terminology used herein is for the purpose of describing particular embodiments only and is not intended to be limiting of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the specification and will not be interpreted in an idealized or overly formal sense unless expressly so defined herein.

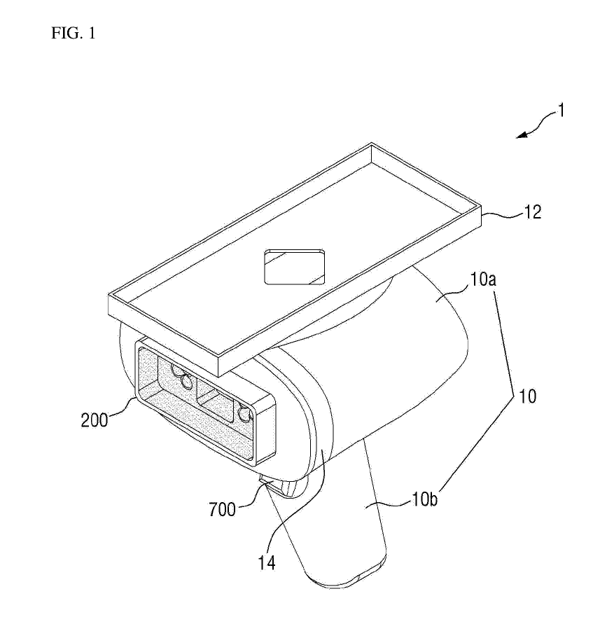

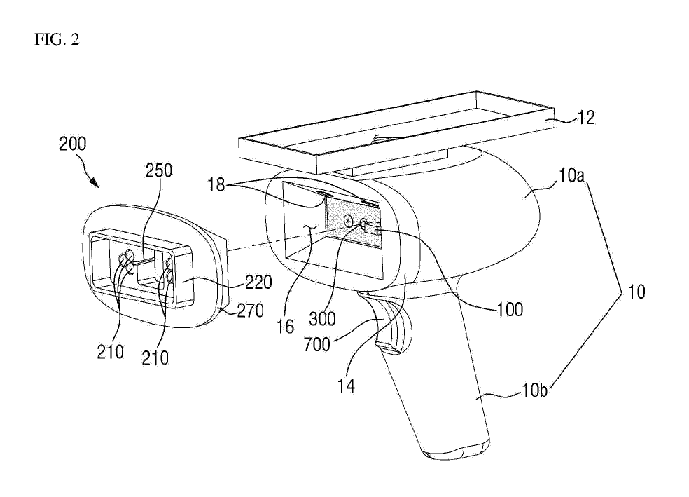

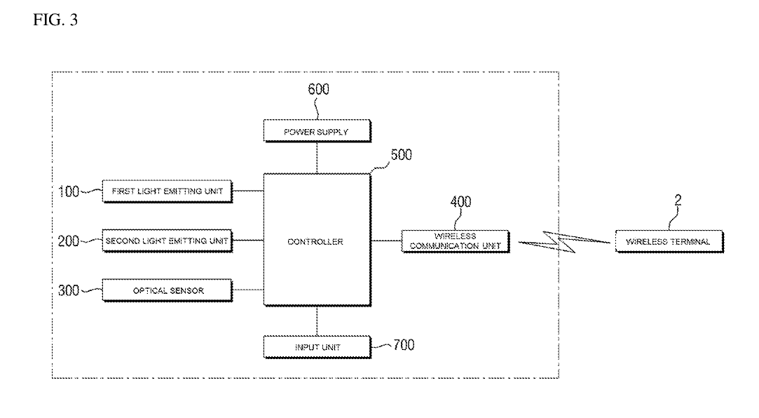

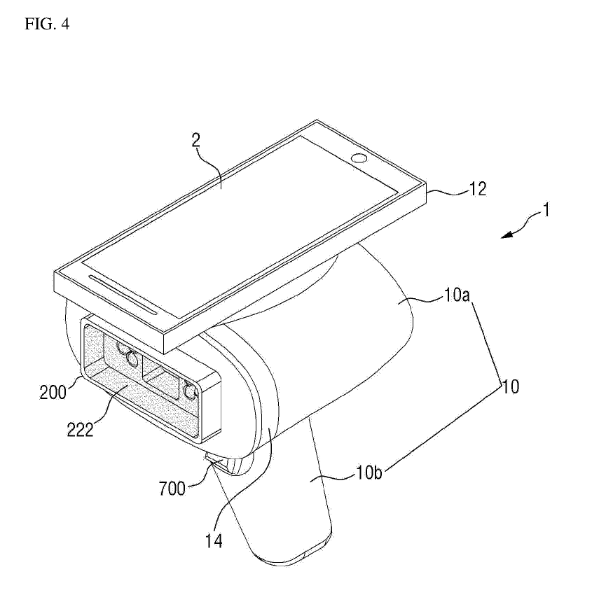

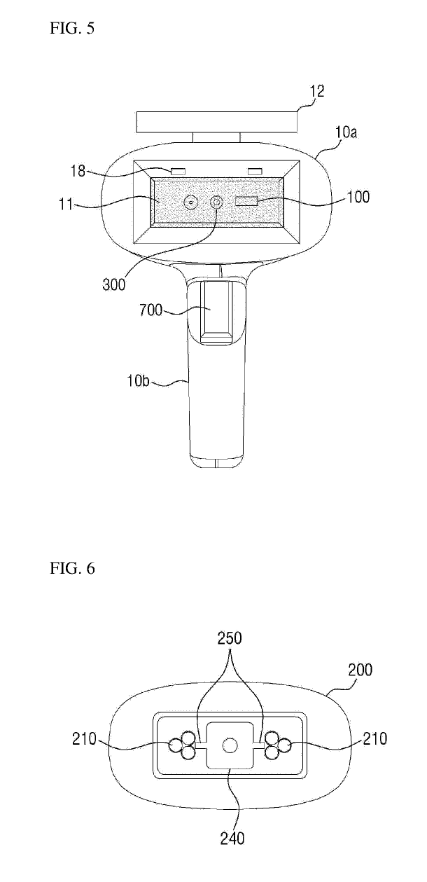

FIG. 1 is a perspective view for describing an image code recognition apparatus according to an embodiment of the present disclosure, FIG. 2 is an exploded perspective view for describing the image code recognition apparatus of FIG. 1, FIG. 3 is a configuration diagram for describing the image code recognition apparatus according to an embodiment of the present disclosure, FIG. 4 is a perspective view for describing an appearance of a wireless terminal mounting portion of the image code recognition apparatus of FIG. 1 when a wireless terminal is mounted thereon, and FIG. 5 is a front view for describing the image code recognition apparatus in which a second light emitting unit of FIG. 1 is separated.

Referring to FIGS. 1 to 3, an image code recognition apparatus 1 according to an embodiment of the present disclosure includes a first light emitting unit 100, a second light emitting unit 200, an optical sensor 300, a wireless communication unit 400, and a controller 500.

In one embodiment, the image code recognition apparatus 1 may further include a power supply 600 and an input unit 700. Here, the first light emitting unit 100, the optical sensor 300, the wireless communication unit 400, the controller 500, and the power supply 600 may be accommodated in a housing 10.

The first light emitting unit 100 may be accommodated in the housing 10 and may emit light in a first region through a transparent window provided on one surface of the housing 10. Here, the first light emitting unit 100 may be operated under control of the controller 500. In one embodiment, the first region may be a visible light region of the electromagnetic spectrum. The first light emitting unit 100 may include a light emitting device, a light emitter, a light emitting component, a light source, and/or the like.

The second light emitting unit 200 may emit light in a second region. Here, the second region may be a non-visible light region of the electromagnetic spectrum. For example, the second region may be an ultraviolet ray region or an infrared ray region. Here, the second light emitting unit 200 may be formed as a separate module or may be inserted and coupled into an internal space formed by a coupling portion 14 of the housing 10 as necessary. The second light emitting unit 200 may include a light emitting device, a light emitter, a light emitting component, a light source, and/or the like

The second light emitting unit 200 will be described below in more detail with reference to FIGS. 6 to 8.

The optical sensor 300 may sense light reflected from an image code. Here, the light reflected from the image code may be the light which is emitted by the first light emitting unit 100 or the second light emitting unit and reflected from the image code. The optical sensor 300 may sense the reflected light through the transparent window provided on the one surface of the housing 10.

In one embodiment, the optical sensor 300 may be composed of an image acquisition element such as a charge-coupled device (CCD) and a complementary metal-oxide-semiconductor (CMOS). The optical sensor 300 may generate image information corresponding to the reflected light and output the image information to the controller 500.

The wireless communication unit 400 may wirelessly communicate with a wireless terminal 2 under the control of the controller 500. Here, the wireless communication unit 400 may wirelessly communicate with the wireless terminal 2 using any one method such as Bluetooth, radio frequency (RF) communication, near-field communication (NFC), Wi-Fi, and Zigbee. The wireless communication unit 400 may include a wireless communication device, a communication device, a transceiver, a transmitter, a receiver, a communication component, and/or the like.

The controller 500 may store information such as image information corresponding to the image code and extract information included in the image code on the basis of the image information generated by the optical sensor 300. The controller 500 may transmit the extracted information to the wireless terminal 2 through the wireless communication unit 400.

Here, the controller 500 may include an analog-to-digital (A/D) converter (not shown) for converting image information generated by a CCD into a digital signal when the optical sensor 300 is the CCD. Further, the controller 500 may include at least one processing unit and at least one memory. Here, the processing unit may include, for example, a central processing unit (CPU), a graphic processing unit (GPU), a microprocessor, an application-specific integrated circuit (ASIC), a field-programmable gate array (FPGA), or the like and may have a plurality of cores. The memory may be a volatile memory, a non-volatile memory, or a combination thereof.

As shown in FIG. 4, the wireless terminal 2 may be mounted in the wireless terminal mounting portion 12 disposed above a head portion 10a and may display the information received through the wireless communication unit 400 and/or product information corresponding to the information. Here, the product information corresponding to the received information may be stored in the wireless terminal 2 in advance or may be received from a server connected via wireless communication. For example, when the wireless terminal 2 receives the information included in the image code from the image code recognition apparatus 1, the wireless terminal 2 may transmit the received information to the server via wireless communication and may receive and display the product information corresponding to the information from the server.

The power supply 600 may supply power required for the image code recognition apparatus 1. Here, the power supply 600 may be a battery type energy storage accommodated in the housing 10 or a power supply unit which supplies power of an external power supply device to parts requiring power through the controller 500.

The input unit 700 may generate an input signal from an input provided by a user and provide the input signal to the controller 500. In one embodiment, the input unit 700 may be formed as an input button so as to be exposed outward from a front surface of a handle portion 10b of the housing 10. The input unit 700 may generate an electrical signal in response to a pressing operation of the input button and output the generated electrical signal to the controller 500. The controller 500 may supply power to the first light emitting unit 100 and/or the second light emitting unit 200 according to the electrical signal, emit the light in the first region and/or the second region to the image code, extract the information included in the image code on the basis of the light sensed by the optical sensor 300, and transmit the information to the wireless terminal 2.

The housing 10 may accommodate the first light emitting unit 100, the optical sensor 300, the wireless communication unit 400, the controller 500, and the power supply 600. Specifically, the housing 10 may include the head portion 10a in which the first light emitting unit 100, the optical sensor 300, the wireless communication unit 400, and the controller 500 are mounted and the handle portion 10b, which extends from the head portion 10a in a lateral direction and allows the user to grip the image code recognition apparatus 1.

The head portion 10a may be provided with a transparent window 11 on a front surface thereof as shown in FIG. 5. When the light which is emitted from the first light emitting unit 100 through the transparent window 11 reaches an image code of a recognition object, then, the head portion 10a reads an electrical signal generated according to the intensity of the reflected light and extracts information of the image code. Therefore, the transparent window 11 is preferably made of transparent glass that at least allows light to enter or exit or of a plastic material that corresponds to the transparent glass. However, since the scope of the present disclosure is not limited thereto, the transparent window 11 may not necessarily have a transparent material. The transparent window 11 may be sufficient if formed with a translucent material, and a certain color may also be added to the transparent window 11 as necessary. Here, the first light emitting unit 100 and the optical sensor 300 may be disposed in the housing 10 so as to emit light through the transparent window 11 and sense the reflected light.

In one embodiment, the wireless terminal mounting portion 12 in which the wireless terminal 2 may be mounted may be formed above the head portion 10a. The wireless terminal mounting portion 12 may be formed to support outer side surfaces of the wireless terminal 2 such that the wireless terminal 2 is inserted and coupled thereto, as shown in FIG. 4 and may have an open upper side so that a display of the wireless terminal 2 may be exposed to the outside.

Further, the front surface of the head portion 10a may include the coupling portion 14 forming an internal space 16 in which the second light emitting unit 200 is inserted and coupled to front ends of the first light emitting unit 100 and the optical sensor 300. Here, the coupling portion 14 may be formed by extending an opening of the front end of the head portion 10a.

The handle portion 10b may extend from the head portion 10a in a lateral direction so that the user may grip the image code recognition apparatus 1, and the input unit 700 may protrude outward from the front surface of the handle portion 10b so that the user may press the input unit 700 with one finger while the user grips the handle portion 10b. Further, the handle portion 10b may accommodate a battery for supplying power to the controller 500.

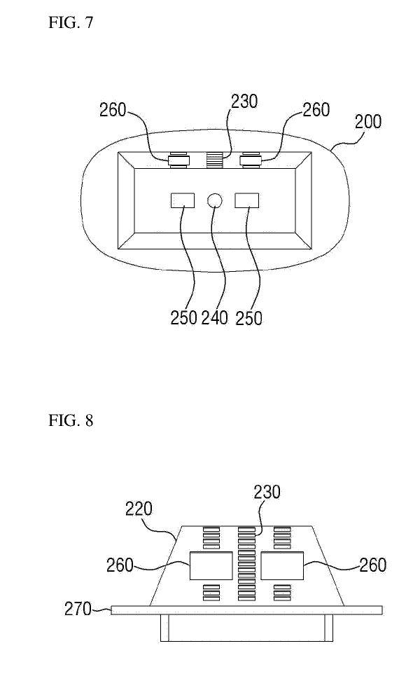

FIG. 6 is a front view for describing the second light emitting unit of FIG. 1, FIG. 7 is a rear view for describing the second light emitting unit of FIG. 1, and FIG. 8 is a plan view for describing the second light emitting unit of FIG. 1.

Referring to FIGS. 6 to 8, the second light emitting unit 200 includes light sources 210 and a second light housing 220.

The light sources 210 may be accommodated in the second light housing 220 and may emit light in the second region. Here, the second region may be a non-visible light region (e.g., an ultraviolet ray region, an infrared ray region or the like). The plurality of light sources 210 may be provided here, and the number of light sources 210 may be appropriately adjusted as necessary.

The second light housing 220 may have an open front surface to allow the light sources to emit light to the front surface thereof, and the front surface may have a shape similar to that of the internal space 16, which is formed by the coupling portion 14 so as to be inserted and coupled to the coupling portion 14 of the housing 10.

A transparent window 222 may be provided on the front surface of the second light housing 220. The transparent window 222 is preferably made of transparent glass that at least allows light to enter or exit or of a plastic material that corresponds to the transparent glass. However, since the scope of the present disclosure is not limited thereto, the transparent window 222 may not necessarily have a transparent material. The transparent window 222 may be sufficient if formed with a translucent material and a certain color may also be added to the transparent window 222 as necessary.

Further, in order for the optical sensor 300 to sense the light reflected from the image code, in the second light housing 220, a first hole 240, which passes through a front surface and a rear surface of the second light housing 220 when the second light housing 220 is inserted and coupled to the coupling portion 14, may be formed at a position corresponding to that of the optical sensor 300.

Further, in order to allow the light emitted by the first light emitting unit 100 to be emitted to the image code, in the second light housing 220, second holes 250, which pass through the front surface and the rear surface of the second light housing 220 when the second light housing 220 is inserted and coupled to the coupling portion 14, may be formed at a position corresponding to that of the first light emitting unit 100.

At least one combining protrusion 230 for improving the coupling force between the second light housing 220 and the coupling portion 14 may be formed on an outer side surface among outer side surfaces of the second light housing 220, which is brought into close contact with an inner side surface of the coupling portion 14 when the second light housing 220 is inserted and coupled to the coupling portion 14.

Further, in order to prevent the light emitted by the first light emitting unit 100 from being exposed to side surfaces of the second light housing 220 when the second light housing 220 is inserted and coupled to the coupling portion 14, the second light housing 220 may include a shielding film 270 formed along an outer circumferential surface of a front end thereof.

Here, in order to supply power to the light sources 210 of the second light emitting unit 200, first power supply terminals 18 connected to the power supply 600 under the control of the controller 500 may be formed on the inner side surface of the coupling portion 14. Further, in the second light housing 220, second power supply terminals 260 may be formed at positions corresponding to that of the first power supply terminals 18 when the second light housing 220 is inserted and coupled to the coupling portion 14. Here, the second power supply terminals 260 may provide power, which is supplied from the first power supply terminals 18, to the light sources 210.

According to an embodiment of the present disclosure, by configuring capability of emitting light in a non-visible light region to be inserted and coupled to a front end of an image code recognition apparatus, image codes displayed by not only light in a visible light region but also light in the non-visible light region can be recognized regardless of a place in which the image codes are recognized or a type of light.

Further, by transmitting information included in the image code to a wireless terminal mounted on a wireless terminal mounting portion of a housing via wireless communication, the information can be displayed on the wireless terminal so that product information recognized using the image code can be directly checked.

Exemplary embodiments of the present disclosure have been described with reference to the accompanying drawings. However, those skilled in the art will appreciate that various modifications, additions and/or substitutions are possible, without materially departing from the scope and spirit of the present disclosure. All such modifications are intended to be included within the scope of the present disclosure as defined by the following claims, with equivalents of the claims to be included therein. Although the present disclosure has been particularly shown and described with reference to exemplary embodiments thereof, it is to be understood that the foregoing is illustrative and is not to be construed as limiting the scope of the present disclosure.

What is claimed is:

1. An image code recognition apparatus, which recognizes an image code, extracts information included in the image code, and transmits the extracted information to a wireless terminal, the image code recognition apparatus comprising:
a first light emitting device configured to emit light, in a first region of an electromagnetic spectrum, towards the image code;
an optical sensor configured to sense light reflected from the image code;
a controller configured to extract the information included in the image code based on the sensed light;
a wireless communication device configured to transmit the information to the wireless terminal via wireless communication;
a housing configured to accommodate the first light emitting device, the optical sensor, the controller, and the wireless communication device; and
a second light emitting device configured to emit light in a second region of the electromagnetic spectrum,
wherein the housing includes a coupling portion forming an internal space in which the second light emitting device is inserted and coupled to a front end of the first light emitting device.

2. The image code recognition apparatus of claim 1, wherein the housing further includes a wireless terminal mounting portion in which the wireless terminal is mounted.

3. The image code recognition apparatus of claim 1, wherein the first region is a visible light region of the electromagnetic spectrum and the second region is a non-visible light region of the electromagnetic spectrum.

4. The image code recognition apparatus of claim 1, wherein the second light emitting device includes:
at least one light source configured to emit light in the second region; and
a second light housing configured to accommodate the at least one light source and configured to be inserted and coupled to the coupling portion.

5. The image code recognition apparatus of claim 4, wherein the second light housing includes:
at least one combining protrusion configured to protrude from an outer side surface of the second light housing and contact an inner side surface of the coupling portion when the second light housing is inserted and coupled to the coupling portion;
a first hole formed at a position corresponding to the optical sensor; and
a second hole formed at a position corresponding to the first light emitting unit.

6. The image code recognition apparatus of claim 5, wherein:
a first power supply terminal for supplying power to the second light emitting device is formed inside the coupling portion; and
a second power supply terminal is formed at a position corresponding to the first power supply terminal in the second light housing.

7. The image code recognition apparatus of claim 5, wherein the second light housing includes a shielding film formed along an outer circumferential surface of a front end of the second light housing in order to prevent light emitted by the first light emitting device from being exposed to side surfaces of the second light housing when the second light housing is inserted and coupled to the coupling portion.
